(19) United States
(12) Patent Application Publication
(10) Pub. No.: US 2008/0055068 A1
(43) Pub. Date: Mar. 6, 2008

(54) Communication Device and Communication System as Well as Method of Communication Between and Among Mobile Nodes

(75) Inventors: Andries Van Wageningen, Wijlre (NL); Marco Ruffini, Dublin (IE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,277

(22) PCT Filed: Jul. 22, 2005
(86) PCT No.: PCT/IB05/52474

§ 371 Date: Jan. 18, 2007

(30) Foreign Application Priority Data
Dec. 22, 2004 (EP) 04106841.2
Jul. 22, 2004 (EP) 04103518.9

(51) Int. Cl. H04Q 7/20

(52) U.S. Cl. 340/539.3

(57) ABSTRACT

In order to provide a method as well as a communication device (100, 100) for communication between and among mobile nodes (10, 12, 14, 16), in particular between and among vehicles, comprising—at least one transmission unit (20), in particular at least one sender block, for broadcasting at least one message (22), in particular at least one hello message and/or at least one warning message, and at least one receiver unit (30), in particular at least one receptor block, for sensing at least one arriving message (32, 34, 36), in particular at least one hello message and/or at least one warning message, being broadcasted by at least one neighboring node (12, 14, 16), wherein a flexible and immediate adjustment of the transmitting power in accordance with the transmitting conditions, for example with the traffic density, is guaranteed, it is proposed to provide at least one controller unit (40), in particular at least one relay control box, for calculating and/or for selecting the transmitting power for broadcasting the message (22).

The present invention relates to a communication device for as well as to a method of communication between and among mobile nodes, in particular between and among vehicles, with each node
broadcasting at least one message, in particular at least one hello message and/or at least one warning message, and
receiving at least one arriving message, in particular at least one hello message and/or at least one warning message, being broadcasted by at least one neighboring node.

A lot of interest has been focused on wireless technology for enabling inter-vehicle communication, for example for enabling wireless local danger warning.

One of the primary objectives of a wireless local danger warning system is to warn as many drivers as possible of an incoming peril. Once a vehicle has recognized a possible danger situation, it should spread a warning message in order to advertise in time other drivers so that they can promptly react to avoid collisions. In this situation it is of primary importance that the messages can reach the highest number of vehicles within a short time, without excessively occupying network resources.

Thus, messages dissemination by means of reliable broadcast has been a focal point up to now. In this context various solutions have been proposed, of which the document by Brad Williams and Tracy Camp, “Comparison of broadcasting techniques for mobile ad hoc networks” [Proceedings of the ACM International Symposium on Mobile Ad Hoc Networking and Computing (MOBIHOC), Jun. 9 to 11, 2002, Lausanne, Switzerland] gives an overview as well as an analysis (cf. also prior art document WO 02/19748 A1).

Generally, car-to-car messages can be exchanged in an ad hoc network by using a M[edium]A[ccess]C[ontrol] protocol like IEEE802.11 that regulates the access to the shared communication medium.

However, in car-to-car ad hoc communication networks, a high density of cars can cause problems for the medium access control protocol like C[arrier]S[ense]M[ultiple]A[ccess]-C[ollision]A[voidance] because a congestion of the shared communication channel can occur due to too many generated messages in a certain area. Thus, the number of medium access attempts can become so high that the network performance collapses under the number of access collisions.

The number of medium access collisions in a region can be lowered by a reduction of the transmitting power of the nodes. However, for low density networks, the nodes should operate with maximum transmitting power in order to keep sufficient connectivity. Thus, another common problem occurs in situations where the car density is low because the connectivity can become too low to exchange sufficient information.

Up to now, improvements on the MAC protocol IEEE802.11 focused on implementations where nodes decide on a peer-to-peer communication level with special R[equest]T[o]S[end]/C[lear]T[o]S[end] signals to optimize their transmitting power. For example, one potential solution could be to set the transmitting power for RTS/CTS to the maximum value and to set the transmitting power for DATA/ACK[nowledgement] to the desired (lower) power level (cf. Eun-Sun Jung, Nitin H. Vaidya: “A Power Control MAC Protocol for Ad Hoc Networks”, Texas A&M University, University of Illinois, Mobicom 2002, Sep. 23-28, 2002, Atlanta, Ga., USA).

Another potential solution might be to change RTS and CTS to R[equest]P[ower]T[o]S[end] and A[cceptable]P[ower]T[o]S[end] to determine the transmitting power of each individual link (cf. Jeffrey P. Monks, Vaduvur Bharghavan, Wen-mei W. Hwu: “A Power Controlled Multiple Access Protocol for Wireless Packet Networks”, University of Illinois, Infocom 2001, Twentieth Annual Joint Conference of the IEEE Computer and Communications Societies, volume 1, pages 219-228, Apr. 22-26, 2001, Anchorage, Ak., USA).

However, it needs to be considered that an important part of the messages being sent by inter-vehicular communication are broadcasted. For broadcast communication, which is especially useful for emergency warnings in a car-to-car communication environment, in many cases no peer-to-peer relation can be utilized for optimization of the transmitting power. Furthermore, for broadcast communication RTS/CTS handshaking is not used. Therefore a different approach is necessary to solve the above-mentioned problems.

In a prior art article by Ram Ramanathan and Regina Rosales-Hain (“Topology Control of Multihop Wireless Networks using Transmit Power Adjustment”, Infocom 2000, BBN Technologies), a transmitting power adjustment is described that adaptively adjusts node transmitting power in response to topological changes. Since in this known system the transmitting power is controlled by the number of established bidirectional neighbour links, which do not explicitly introduce control overhead, the adjustment of transmitting power causes link-ups/link-downs which decreases the effective throughput.

Moreover, in prior art document GB 2 348 572 A, a system for controlling transmit power of nodes by means of a look-up table is disclosed.

The problem of adjusting the transmit power of nodes in a multihop wireless network or so-called ad hoc network is discussed in prior art document WO 03/079611 A1.

Apart from that, prior art document WO 02/03567 A2 proposes to make each node use a particular power level for each destination. In order to do so, each node maintains a power cache where the power level information is stored.

In a prior art article by Seung-Jong Park and Raghupathy Sivakumar (“Quantitative Analysis of Transmitting power Control in Wireless Ad Hoc Networks”, Proceedings of International Workshop on Ad Hoc Networking (IWAHN), Vancouver, Canada, August 2002), it is proposed that the optimal transmission power in a wireless ad hoc network is dependent on the network environment defined by the traffic load, by the number of mobile stations and by the network grid area.

However, this wireless ad hoc network is not able to allow nodes in the network to estimate a power level to use for transmitting to a particular node before the transmission and to adjust the value of the power level in a flexible way as transmitting conditions, for example traffic density, change.

Thus, all these techniques only resolve the problem of reachability for a general scenario, which leads to a sub-optimal solution when considering inter-vehicle communication scenarios. For this reason a solution is needed by which the trade-off between message reachability and interference generated can be optimized and which can be adapted to various traffic situations.

Solutions evaluating the signal received to calculate a suitable transmitted power are disclosed in prior art document EP 0 898 382 A2 but these solutions refer to unicast communication.

Prior art document WO 02/03567 A2 refers to power control techniques in wireless network for reducing mobile nodes' power consumption and for achieving lower signal-to-interference ratio. This conventional power control scheme for distributed networks discloses a method for adapting and storing the power level for transmission between the nodes. For each node communicating with other nodes in the network the power level is calculated and stored in the node's memory (power cache) wherein each node continuously builds up its power cache. The calculation of the required transmission power level is done either at the receiving node or at the transmitting node. The resulting calculated power level is stored at the transmitting node for reference and for use in future transmissions.

A solution proposing power control for broadcast transmission is also suggested in the document by Xiaohu Chen, Michalis Faloutsos, and Srikanth V. Krishnamurthy, “Power adaptive broadcasting with local information in ad hoc networks” [Network Protocols, 2003, Proceedings, eleventh IEEE International Conference on Nov. 4 to 7, 2003, pages 168 to 178]; this document proposes to calculate the transmitted power considering distance of neighbors and a simplified path-loss model.

In this context, reference can also be made to prior art document U.S. Pat. No. 6,735,448 B1 relating to power management within the context of wireless ad-hoc networks, more specifically to the effects of using different transmit powers on the average power consumption and end-to-end network throughput in a wireless ad-hoc environment.

However, the drawback is that the path-loss model is too simple to be consistent with a road environment which can give the whole system a low reliability.

Starting from the disadvantages and shortcomings as described above and taking the prior art as discussed into account, an object of the present invention is to provide a communication device as well as a method for communication between and among mobile nodes, wherein a flexible and immediate adjustment of the transmitting power in accordance with the transmitting conditions, for example with the traffic density, is guaranteed.

The object of the present invention is achieved by a communication device comprising the features of claim 1 as well as by a method comprising the features of claim 14. Advantageous embodiments and expedient improvements of the present invention are disclosed in the respective dependent claims.

Hence, the present invention is principally based on the idea
of varying the power transmitted in particular depending on values related to the traffic conditions and
of thus providing a power control mechanism for broadcast transmission by means of at least one corresponding power controlled safety system.

Therefore according to a preferred embodiment of the present invention the transmitting power is calculated in broadcast communication by processing information received from neighboring nodes; in particular, the path loss of every neighboring node is calculated by using the difference between the power transmitted value and the power at which the message is received. This leads to the advantage that message reachability is maximized without penalizing bandwidth occupation.

The present invention is in particular based on the idea of distributing the power control in ad hoc wireless networks, i.e. of selecting the power level favorably on the basis of the density of nodes in a region. To this aim, the power level of advantageously each node can be adapted e.g. to the change of the amount of nodes in its neighborhood. According to a preferred embodiment of the present invention, the transmitting power of a node can be adapted depending on the density of cars measured by the number of sensed cars in the neighborhood.

In particular, the transmitting power can be reduced with increasing number of arriving messages, for example when the number of arriving messages is higher than a predetermined threshold. Moreover, advantageously the transmitting power is increased with decreasing number of arriving messages, for example when the number of arriving messages is lower than a predetermined threshold. By using this procedure, the nodes can try to keep their number of sensed nodes constant. Furthermore, this embodiment of the present invention leads to the advantage that oscillation of increasing and decreasing transmitting power is avoided.

In a further preferred embodiment of the present invention, the communication device comprises at least one localization unit, in particular at least one position determining unit, for example at least one G[lobal]P[ositioning]S[ystem] unit, for determining the position of the respective node, in particular for determining the localization of the reference node within at least one group of nodes.

Said localization unit is advantageously connected to the controller unit and designed for receiving signals via at least one localization antenna, for instance via at least one G[lobal]P[ositioning]S[ystem] antenna, in particular regarding the current position of the respective node and/or regarding the moving direction of the respective node.

Independently thereof or in connection therewith, the selection of the transmitting power is advantageously dependent on the localization of the respective node within at least one group of nodes. Hence for example at least one node in the central area of the group can have a lower transmitting power than a node in the border area of the group.

According to a preferred embodiment of the invention, the communication device is designed for wireless local danger warning, in particular for disseminating warning messages among all the neighboring nodes, for example among drivers of vehicles possibly involved in a danger situation.

Focal point of the present invention is therefore the controller unit, in particular embodied by at least one relay control box optionally
storing information about the neighboring nodes,
processing this information and
calculating the optimal control power to use for relaying the message(s) generated.

To assure high reachability on the one hand and low consumption of network resources on the other hand, the controller unit advantageously comprises at least one power control subsystem being designed for adapting the transmission power or transmitting power of the communication device to an optimum value, based on information of neighboring nodes.

Thus the communication device, in particular the controller unit, is preferably in charge of creating, of displaying and of transmitting at least one warning message when at least one danger situation is revealed by at least one sensor.

Moreover, according to a preferred embodiment of the present invention the communication device, in particular the controller unit, is preferably in charge of relaying the message, in particular the warning message, if said message is received by the neighboring node, for example by another vehicle, using the same communication device or a similar communication device.

To this aim, according to an advantageous embodiment of the present invention the communication device is embedded on a node, in particular on a vehicle representing such node, and is
designed for sensing a danger as well as
designed for triggering at least one warning message generator,
wherein the warning message generator creates at least one warning message to be forwarded to the neighboring nodes, in particular to other vehicles in the neighboring of the considered and/or respective node.

Preferably, all the other nodes are furnished with the communication device according to the present invention. According to an advantageous embodiment of the present invention, on receipt of the arriving broadcast message at least one message analyzer evaluates if this arriving broadcast message is a hello message or a warning message:
in case the arriving message is a hello message the advantageous embodiment of the present invention uses this hello message to update at least one neighbor table or neighbor list, as explained below;
in case the arriving message is a warning message the advantageous embodiment of the present invention sends
at least one copy of the warning message to at least one display unit, which warns the driver of the incoming peril, for instance by acoustical and/or optical means, and
at least another copy to at least one retransmission controller, which evaluates if the message has to be retransmitted and in that case calculates the transmitting power by processing information about neighboring nodes, in particular about neighboring vehicles.

Every vehicle endowed with this communication device according to an advantageous embodiment of the present invention periodically transmits said hello message
which contains information about
the power transmitted,
the current position (supplied by at least one localization unit, in particular by at least one G[lobal]P[ositioning]S[ystem] unit),
the direction of moving (supplied by said localization unit),
the speed (supplied by at least one car bus interface),
the network identification number, and/or
the timestamp, and
which optionally includes other relevant information, for example the receiver sensitivity.

According to a preferred embodiment of the present invention, the localization unit, in particular the G[lobal]P[ositioning]S[ystem] module, is important for the content of the warning message. However, the localization unit, in particular the G[lobal]P[ositioning]S[ystem] module, is not strictly necessary
for the handling of the hello message, in particular
for the generation of the hello message and/or
for the storage of the neighbor list or neighbor table and
for the functioning of the calculation of the transmitting power, in particular for the functioning of at least one power control algorithm.

Said hello messages are transmitted in broadcast mode; thus, every node able to sense the hello message can create an entry in its neighbor list or neighbor table and optionally update the information every time a new hello message from the same neighboring node is received.

When no hello message is received from a given neighboring node for a certain time period, that can be fixed by defining the value of the parameter “Max_Time” in the communication device, the entry relative to that given neighboring node is deleted from the neighbor list or neighbor table of the node that has not received the hello message for a certain time period.

According to an advantageous embodiment of the present invention, the neighbor table includes for each entry the same information contained in the correspondent hello message, plus a field named “Path Loss”.

According to said advantageous embodiment of the present invention, this field “Path Loss” is an expedient feature of the power control subsystem included in the controller unit, in particular included in the relay control box.

Advantageously, every time said arriving message is received, at least one power estimator unit calculates the power at which the arriving message is received. By subtracting this measured value from the power transmitted value, which is included in the arriving message received, the controller unit, in particular the relay control box, calculates the path loss value, which is preferably stored in the correspondent entry in the neighbor table or neighbor list.

In order to have information more updated, the hello message can be included as a header on all types of messages transmitted by the communication device.

In a further preferred embodiment of the present invention, when the retransmission controller or the warning message generator requests to transmit the broadcast message, the power control subsystem sorts first all the entries in the neighbor list for increasing values of the path loss calculation.

In order to make the implementation simpler, the entries can also be grouped into discrete intervals, whose span can be defined in a parameter called “Interval_Span”.

Moreover, according to a preferred embodiment of the present invention the controller unit, in particular the relay control box, also has a parameter “Target_Neighbors” indicating the average number of neighboring nodes that should be able to receive the message within that particular retransmission.

The controller unit, in particular the relay control box, preferably runs then an algorithm, in particular the power control algorithm, summing the number of neighboring nodes contained in each interval starting from the one with lower values of “Path Loss”, until the sum gives a number that is equal to or bigger than the parameter “Target_Neighbors”.

At that point, according to a preferred embodiment of the present invention, the algorithm stops and returns to the controller unit, in particular to the relay control box, the value “PL” of the path loss corresponding to the last interval calculated.

Independently thereof or in connection therewith, the controller unit preferably contains at least one sensitivity parameter “Min_Sensitivity” indicating the minimum power being receivable by at least one receiving node in order to correctly decode the message. This value is standard and depends on the receiver type adopted, in particular on the receiver being used in the communication device.

Moreover, according to a preferred embodiment of the present invention the controller unit, in particular the relay control box, calculates at least one N[et]T[ransmission]P[ower] by subtracting the sensitivity parameter “Min_Sensitivity” from the value “Path Loss”.

In order to consider possible power losses in both the transmitting system and the receiving system (, i.e. in the communication device of the respective node transmitting the message as well as in the communication device of the neighboring node receiving the message), the controller unit, in particular the relay control box, calculates at least one G[ross]T[ransmission]P[ower] by summing at least one safety margin value to the value N[et]T[ransmission]P[ower].

In other words, the value NTP may be calculated based
on an averaged value of path loss of the target receivers,
the minimum receiver power and
a safety margin value.

Said safety margin can be defined as parameter “Margin” in the communication device. The value GTP represents the transmitting power used by at least one transmission unit of the communication device to deliver the message.

Grouping the neighboring nodes in classes of path loss and considering a certain number of neighboring nodes as targeted receivers (as defined in the parameter “Target_Neighbors”) leads to the advantage that the controller unit, in particular the power control subsystem, can work on an averaged value of the path loss, which proves to be very useful in order to face the fast fading phenomenon due to multi-path propagation of the radio signal, which is very typical in road environment.

Beside that, the communication device as described above is capable of adapting the transmitting power to the traffic conditions, in particular to the number of neighboring nodes. In case of low traffic in fact vehicles are distant from each other and high transmitting power is needed to overcome the path loss. On the other hand, in case of high traffic, high transmitting power translates directly into high levels of interference, which inevitably decreases system performances.

To maximize message reachability without penalizing bandwidth occupation, according to a preferred embodiment of the present invention the transmitting power
can be reduced with increasing number of arriving messages and
can be increased with decreasing number of arriving messages.

Furthermore, the communication device as described above is capable of adapting the transmitting power to the transmitting channel, in particular by means of path-loss evaluation. Thus, a communication device using wireless connection to implement at least one safe driving concept and being capable of adaptation to many different scenarios can be provided by the present invention.

This adaptation capability represents an important advantage in inter-vehicle communication environment, where the number of nodes can vary from less than one unit per kilometre of road (typical of out-of-city scenarios at night time) to more than hundred units per kilometre (typical of motorway scenarios at peak hours).

The communication device as described above can also be included as a part of a more complex protocol stack for at least one multi-purpose communication device. Said communication device can substitute the general broadcast subsystem of any protocol, providing the protocol with a reliable broadcast mechanism with power control subsystem. In fact, basically every network protocol makes use of broadcast message dissemination.

Thus, the communication device according to the present invention can be installed in any vehicle, in particular in any vehicle moving on a road. Moreover, the communication device according to the present invention can constitute by itself a complete structure to achieve wireless local danger warning, with the ability of self-adaptation to different circumstances and scenarios. Furthermore, the communication device according to the present invention can also be included as a part of a more complex protocol stack as explained above.

For example, a general protocol can embody the present invention to disseminate messages generated by an application layer with the purpose of message delivery or by any part of layer management with purposes of exchange of service messages.

It is a further object of the present invention to provide a communication device wherein a flexible and immediate adjustment of the receiver sensitivity in accordance with the transmitting conditions, for example with the traffic density, is guaranteed.

The object of adjusting the optimal receiver sensitivity is achieved by a communication device comprising the features of claim 11 as well as by a method comprising the features of claim 19. Advantageous embodiments and expedient improvements of the present invention are disclosed in the respective dependent claims.

This feature can be implemented in an advantageous embodiment by increasing the receiver sensitivity with a certain percentage when the number of nodes being sensed by the respective node is lower than the average number of nodes, and by decreasing the respective receiver sensitivity with a percentage smaller than the certain percentage when the number of nodes being sensed by the respective node is higher than the average number of nodes.

The number of sensed nodes is not necessarily a criterion for the receiver sensitivity. Thus, it is possible that a node being at the border area of a group senses a lower number of nodes than a node being at the central area of the same group, even if all nodes have the same receiver sensitivity. Because of this situation, for example the node being at the border area of the group can make use of a higher transmitting power than the node being at the central area of the same group, no matter what the node at the border area knows about its position in the group.

The present invention further relates to a communication system for communication between and among mobile nodes, in particular between and among vehicles, comprising at least two communication devices as described above, wherein
at least one of the communication devices is assigned to the reference node or respective node, in particular to the considered car, and
at least one of the communication devices is assigned to the neighboring node, in particular to the neighboring car.

According to a preferred embodiment of the invention each node comprises at least one communication device according to at least one of claims 1 to 11.

In the following, a preferred example of the method of the present invention is disclosed:

Two nodes (=car A and car B) are almost at the same location, but have different sensitivity. The car with lower sensitivity, in the following car A, senses less other cars than the other car, in the following car B. In this situation, car A might increase its transmitting power and car B might decrease its transmitting power.

Suppose the other cars in the neighborhood are all within the state that they will not change their transmitting power because the number of sensed cars for each car is rather within the required range, then a change of transmitting power of cars A and B probably will have no effect on the transmitting power of the other cars. This means that nodes A and B will still sense a different number of cars and are not able to have the required effect by changing their transmitting power.

By exchanging the information on the number of sensed cars, car A will find out that other cars are relatively more sensitive and car B will find out that other cars are relatively less sensitive. Car A will increase its sensitivity and car B will reduce its sensitivity. Car A will now sense more other cars and will no longer increase its transmitting power, or will even start to decrease its transmitting power. Car B will now sense less other cars and will no longer decrease its transmitting power, or will even increase its transmitting power.

The present invention finally relates to the use of a communication system as described above and/or of the method as described above
for at least one multi-purpose communication device, in particular for providing a reliable broadcast mechanism with power control subsystem, and/or
for at least one wireless ad hoc network, in particular for at least one sensor network or for wireless local danger warning with the ability of self-adaptation to different circumstances and scenarios, for example for car-to-car communication, wherein cars interact cooperatively and distribute for example warning messages, especially for accident-free driving, for instance
in order to avoid collisions during lane change or merge manoeuvres and
for reporting invisible obstacles, for example obscured or shadowed objects,
when vehicles are moving in different directions within the same area.

The core part of the communication system as described above (implementing the concept of power controlled broadcast and thus of power controlled safety system) can be embedded in any communication protocol making use of broadcast transmission.

In addition, it will be appreciated by the artisan that the controller unit, in particular the relay control box, for example the power control algorithm, enables to save battery power. Thus, the present invention relates to all types of ad-hoc communication systems or ad-hoc communication networks providing an independent peer-to-peer connectivity, i.e. for instance to wireless ad-hoc sensor networks.

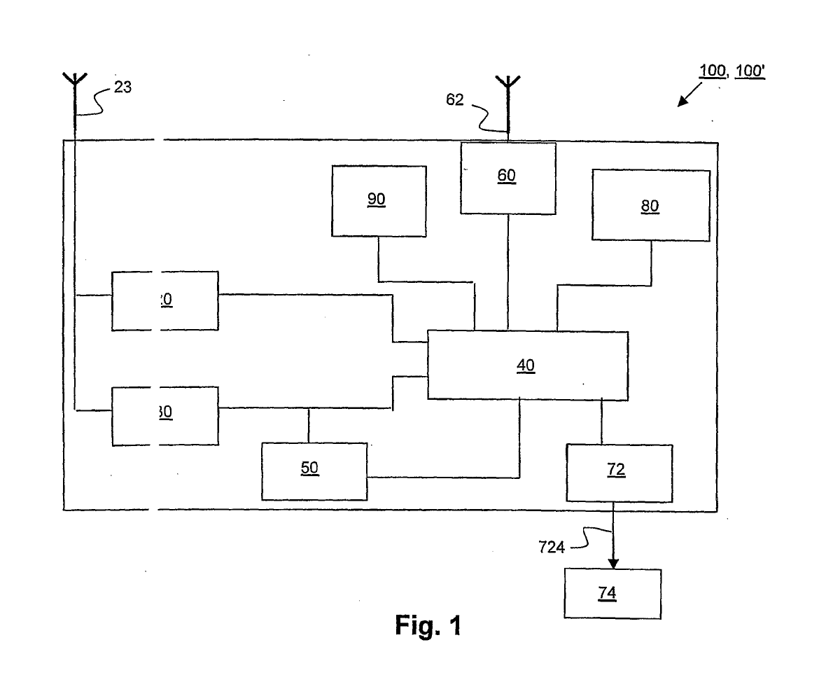

As already discussed above, there are several options to embody as well as to improve the teaching of the present invention in an advantageous manner. To this aim, reference is made to the claims dependent on claim 1, on claim 12 and on claim 14; further improvements, features and advantages of the present invention are explained below in more detail with reference to a preferred embodiment (cf. FIG. 1 to FIG. 8C) by way of example and to the accompanying drawings where

FIG. 1 schematically shows an embodiment of a communication device according to the present invention being operated according to the method of the present invention;

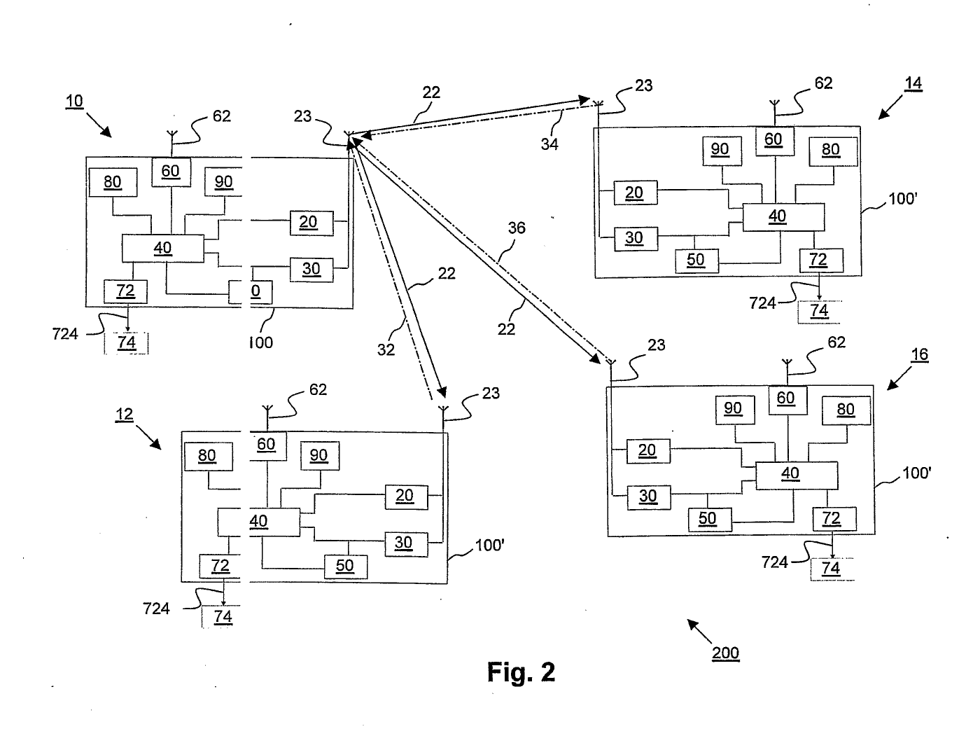

FIG. 2 schematically shows an embodiment of a communication system according to the present invention comprising four communication devices of FIG. 1;

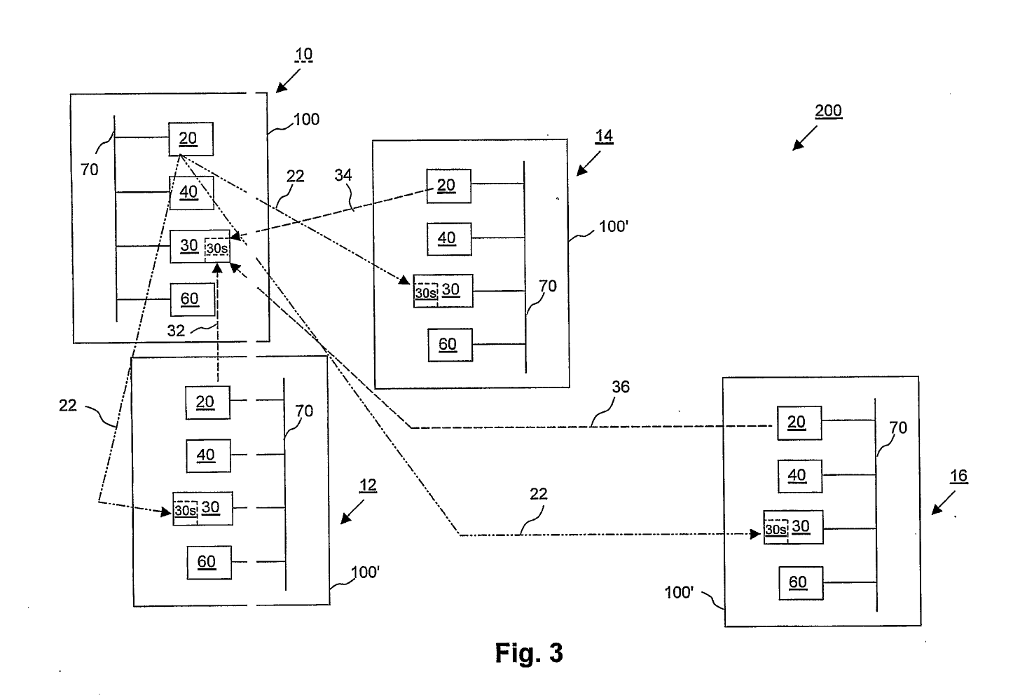

FIG. 3 schematically shows an alternative implementation of the communication system according to the present invention being operated according to the method of the present invention;

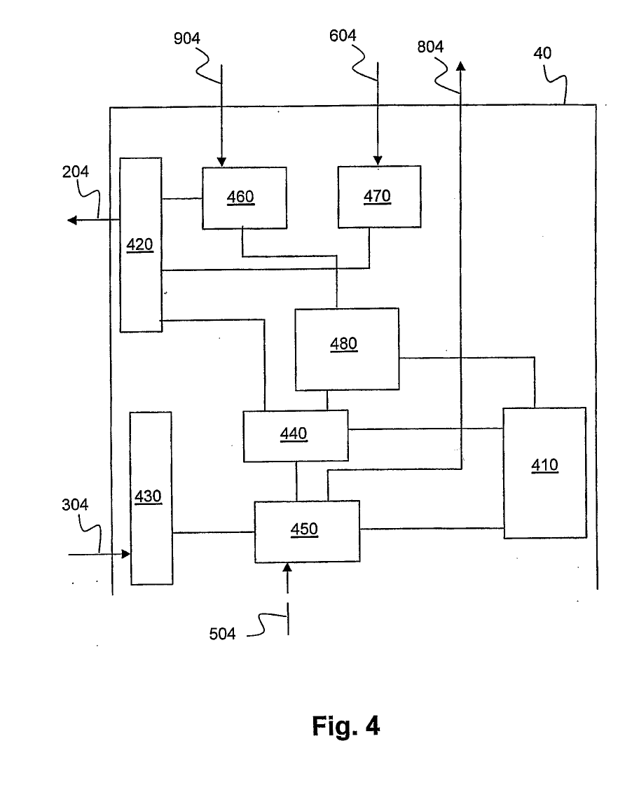

FIG. 4 schematically shows in more detail the controller unit or relay control box of the communication device of FIG. 1;

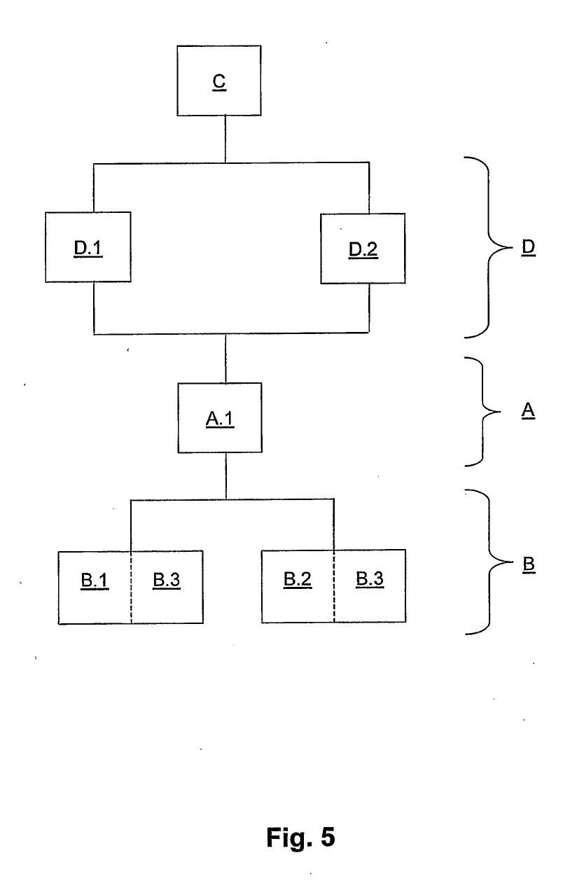

FIG. 5 schematically shows an example for the method according to the present invention;

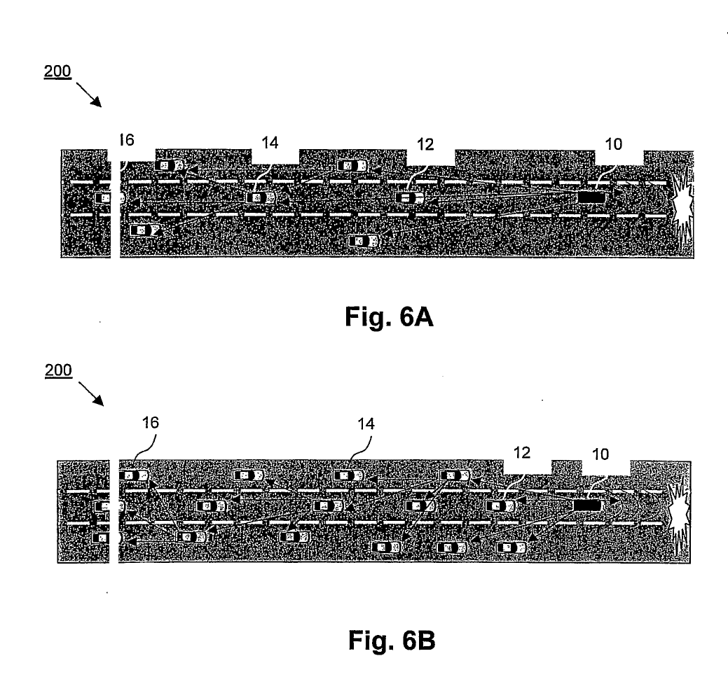

FIG. 6A schematically shows in accordance with the present invention an example for application of inter-node (=inter-vehicular) communication in case of a peril ahead and in case of low traffic density;

FIG. 6B schematically shows in accordance with the present invention a further example for application of inter-node (=inter-vehicular) communication in case of a peril ahead and in case of high traffic density;

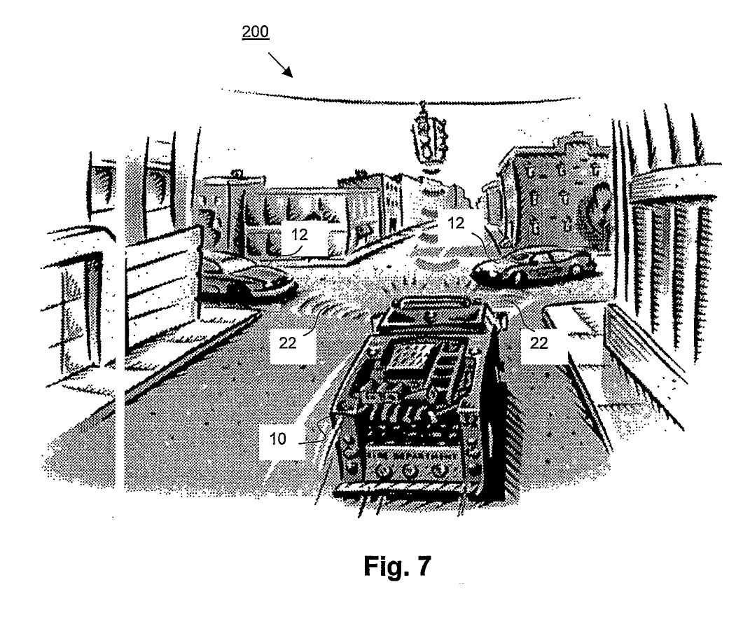

FIG. 7 perspectively shows in accordance with the present invention a further example for application of inter-node (=inter-vehicular) communication in case of a crossing or of an intersection;

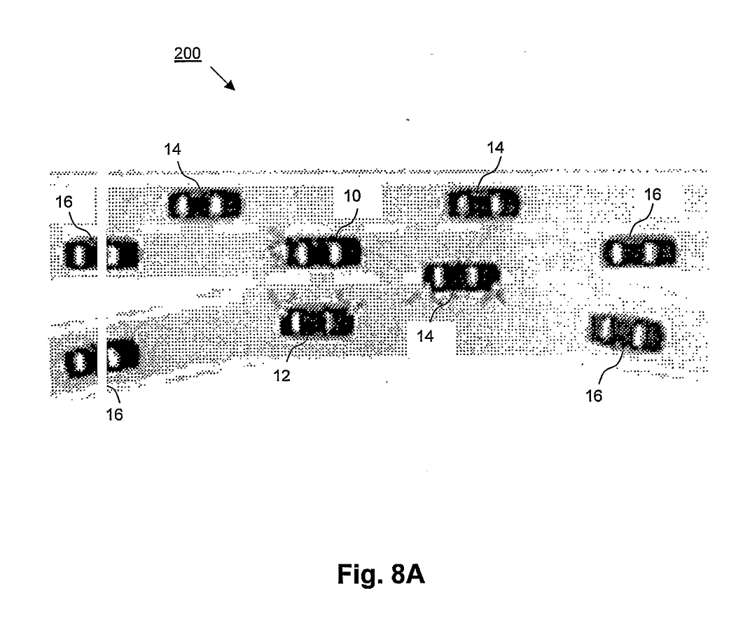

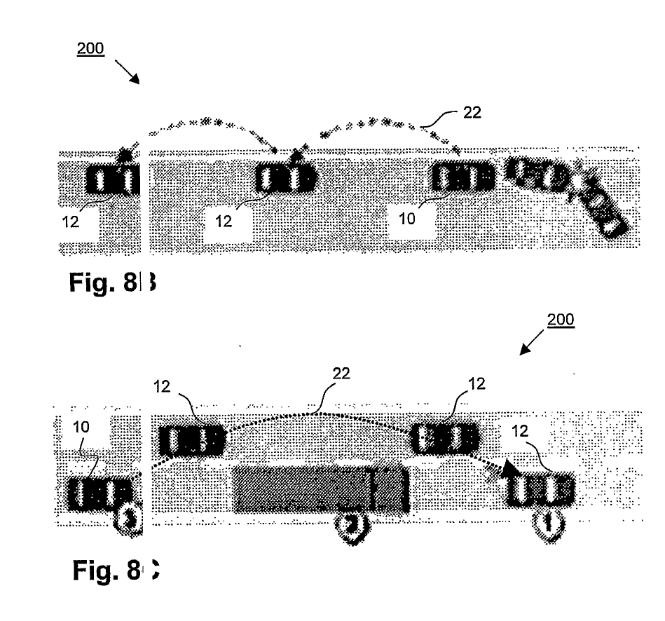

FIG. 8A schematically shows in accordance with the present invention a further example for application of inter-node (=inter-vehicular) communication in case of a lane change manoeuvre;

FIG. 8B schematically shows in accordance with the present invention a further example for application of inter-node (=inter-vehicular) communication in case of an accident ahead; and

FIG. 8C schematically shows in accordance with the present invention a further example for application of inter-node (=inter-vehicular) communication in case of an invisible obstacle.

The same reference numerals are used for corresponding parts in FIG. 1 to FIG. 8C.

In order to avoid unnecessary repetitions, the following description regarding the embodiments, characteristics and advantages of the present invention relates (unless stated otherwise)
to the embodiment of the communication system 200 according to the present invention (cf. FIG. 2) as well as
to the alternative implementation of the communication system 200 according to the present invention (cf. FIG. 3), all embodiments 200 being operated according to the method of the present invention.

FIG. 1 depicts a communication device 100, 100′ for communication between and among mobile nodes 10, 12, 14, 16, for example between and among a reference vehicle 10 (=considered car, in particular respective car) and neighboring cars 12, 14, 16. An example for an inter-node communication system, namely for a power controlled car-to-car safety system 200 is depicted in FIG. 2, wherein each car 10, 12, 14, 16 comprises the communication device 100, 100′ as shown in FIG. 1.

The communication device 100, 100′ comprises
a transmission unit 20, namely a sender block, for broadcasting messages 22, comprising hello messages and warning messages,
a receiver unit 30, namely a receptor block, for sensing arriving messages 32, 34, 36, namely hello messages and warning messages, being broadcasted by the neighboring cars 12, 14, 16, and
a controller unit 40, namely a relay control box, for calculating the transmission power or transmitting power for broadcasting the message 22 by processing part of the arriving message 32, 34, 36, in particular by processing information regarding the neighboring cars 12, 14, 16.

The receiver unit 30 is connected
to a receiving/transmitting antenna 23 and
to the relay control box 40 as well as to a power estimating unit 50 being designed for calculating the receiving power 504 at which the arriving message 32, 34, 36 is received.

The receiving/transmitting antenna 23 is assigned to the transmission unit 20 as well as to the receiver unit 30.

For receiving signals
regarding the current position of the considered car 10 and/or
regarding the moving direction of the considered car 10 via a localization antenna 62, namely via a G[lobal]P[ositioning]S[ystem] antenna, the relay control box 40 is connected with a localization unit 60, namely with a G[lobal]P[ositioning]S[ystem] unit.

Moreover, the relay control box 40 is connected with a danger sensing unit 90 being designed for sensing one or more subjects being relevant, in particular dangerous, for the considered car 10 and/or for the neighboring cars 12, 14, 16.

To be supplied with the speed of the considered car 10, the relay control box 40 is connected with a car bus interface 72. Said car bus interface 72 supplies a car bus intra-vehicle system 74 with signals 724 being sent from the car bus interface 72 to the car bus intra-vehicle system 74.

Moreover, the communication device 100, 100′ comprises a display unit 80 displaying messages, in particular the arriving messages 32, 34, 36, for example the warning messages. Said display unit 80 again is connected to the relay control box 40.

In FIG. 3, a different implementation of an arrangement for an inter-node communicating system, namely a car-to-car communication system 200, according to the present invention is depicted.

A group of cars, namely
the considered car (=reference node 10),
neighbouring cars (=first nodes 12),
several cars (=second nodes 14) being at the central area of the group and
several cars (=third nodes 16) being at the boarder area of the group are communicating by means of a wireless ad hoc network. According to the present invention, a distributed power control is provided for this wireless ad hoc network.

Each car 10, 12, 14, 16 comprises a respective data bus 70 to which a respective transmission unit 20, a respective receiver unit 30 comprising a selection part 30s, a respective controller unit 40 and a respective localization unit 60 are connected. Moreover, each car 10, 12, 14, 16 comprises facilities and conditions as follows (, which are depicted for reasons of clarity exemplarily with respect to reference car 10):

The reference car 10
periodically broadcasts an alive message 22 to all neighboring cars 12, 14, 16 (if a node 10 emits an alive message 22, this alive message 22 is received by all other nodes 12, 14, 16 in the environment of the node 10; for this reason, the term “broadcast” is used),
can sense the alive messages 32, 34, 36 of the other cars 12, 14, 16 in its neighborhood by means of the receiver unit 30,
can change its transmitting power by means of the controller unit 40,
keeps track on the number of sensed cars 12, 14, 16 by means of the receiver unit 30,
can change the receiver sensitivity by means of the selection part 30s of the receiver unit 30, and
can determine its position by means of the localization unit 60.

Thus the car 10 adapts its transmitting power depending on the number of sensed cars 12, 14, 16 in the neighborhood. If the number of sensed cars 12, 14, 16 is high, the considered car 10 will reduce the transmitting power, and if the number of sensed cars 12, 14, 16 is low, the considered car 10 will increase the transmitting power.

Advantageously, each car 10, 12, 14, 16 in the network 200 behaves the same in this respect. Therefore, if the number of cars 10, 12, 14, 16 in a certain region is high, most cars 10, 12, 14, 16 (perhaps except the cars 16 at the border of the region where the density might be lower) will reduce their transmitting power. The reduction of the transmitting power will have the result that cars will become out of range and thus less other cars will be sensed; in case the cars 16 reduce their respective transmitting power, these cars 16 come out of the sensing range of the other cars 10, 12, 14, 16, starting with the cars 16 at the opposite side of the region (cf. FIGS. 6A, 6B, 8A).

By adapting the transmitting power depending on the traffic density the cars 10, 12, 14, 16 can try to keep their number of sensed neighboring cars as constant as possible.

Apart from that, the present invention also enables the cars 14 in the middle of a condensed group to have a lower transmitting power than the cars 16 at the outside of the group. This might be a preferred situation because it helps to bridge the communication between groups.

In order to avoid oscillation of increasing and decreasing transmitting power, a threshold limits the adaptation of the transmitting power; this adaptation of the transmitting power is for instance carried out incrementally and/or decrementally.

In order to achieve such incremental and/or decremental adaptation of the transmitting power, the following technical algorithm is used:
if the number of nodes is higher than the required number plus an offset,
then the node reduces its transmitting power by an decrement delta;
if the number of nodes is lower than the required number less the offset,
then the node increases its transmitting power by the increment delta.

Moreover, as described above each car 10, 12, 14, 16 can adjust its receiver sensitivity. Such adjustability is important in case the considered car 10 continues to send with high transmitting power although the other cars 12, 14, 16 have reduced their power. If this considered car 10 has the task to connect a group to another group, this situation is acceptable. Otherwise, this situation is problematic because the considered car 10 has a very low sensitivity for the other cars 12, 14, 16. This problem of very low sensitivity can be solved by adjusting the receiver sensitivity to the average receiver sensitivity of the other cars 12, 14, 16.

To be able to adapt the reception sensitivity, the car 10 and/or the cars 12, 14, 16 periodically broadcast the messages 22 and/or 32, 34, 36 including a respective value representing the number of cars as respectively sensed. Thus, the car 10 broadcasts the message 22 to the other cars 12, 14, 16. Furthermore, the car 12 broadcasts the message 32, the car 14 broadcasts the message 34, and the car 16 broadcasts the message 36. The reference car 10 receives the message 32 from the car 12, the message 34 from the car 14 and the message 36 from the car 16 (cf. FIG. 2).

From the received values, each car 10, 12, 14, 16 calculates the average number of sensed cars. Hereby, those values are taken into account that are received from each neighboring car in the period which starts at the actual time minus a predefined offset, and ends at the actual time. To prevent oscillation, the change of the receiver sensitivity is carried out in small steps (or increments and decrements).

In this context, it appears important to prevent a situation where all nodes 10, 12, 14, 16 will lower their sensitivity simultaneously, which would cause a drifting to a situation where all nodes 10, 12, 14, 16 have minimum sensitivity; to avoid such simultaneous drifting the increase function for the sensitivity is sharper than the decrease function.

This leads to the following algorithm:
if the number of sensed nodes, in particular of sensed cars, is lower than the average number of sensed nodes, in particular than the average number of sensed cars, then the sensitivity is increased by x percent;
if the number of sensed nodes, in particular of sensed cars, is higher than the average number of sensed nodes, in particular than the average number of sensed cars, then the sensitivity is decreased by fx percent, wherein the “damping” factor f is between 0 and 1.

Because the increase function is sharper than the decrease function, the cars 10, 12, 14, 16 tend to become more sensitive until a number of the cars 10, 12, 14, 16 have reached their maximum receiver sensitivity.

In FIG. 5, the startup of the communication system 200 is schematically depicted. The considered car 10 is initialized with maximum receiver sensitivity and maximum power. As soon as the considered car 10 detects the other cars 12, 14, 16, the considered car 10 first adapts its receiver sensitivity to the other cars 12, 14, 16. To achieve this technical aim, the reference car 10
(C) calculates the average number of sensed cars by means of the values in the received messages 32, 34, 36 representing the number of cars being sensed by the respective neighboring cars 12, 14, 16, and
(D) adapts its receiver sensitivity dependent on the calculated average number of sensed cars; in particular, the considered car 10
(D.1) increases the respective receiver sensitivity with a certain percentage when the number of cars being sensed by the considered car 10 is lower than the average number of sensed cars and
(D.2) decreases the respective receiver sensitivity with a percentage smaller than the certain percentage when the number of cars being sensed by the considered car 10 is higher than the average number of sensed cars.

When the number of sensed cars exceeds the required number plus the offset, the considered car 10 will reduce its transmitting power. For this purpose, the considered car 10
(A) determines the distance and the number of the neighboring cars 12, 14, 16 by means of the arriving messages 32, 34, 36, in particular
(A.1) determines its localization within the group of cars 10, 12, 14, 16. After that, the car 10
(B) selects the transmitting power for sending the messages 22 in dependence on the distance and number of neighboring cars 12, 14, 16; in doing so, the considered car 10 either
(B.1) reduces its transmitting power when the number of arriving messages 32, 34, 36 is higher than a predetermined threshold, and
(B.3) optionally adapts the transmitting power dependent on its localization within the group of cars 10, 12, 14, 16.

Alternatively, the considered car 10
(B.2) increases its transmitting power when the number of arriving messages 32, 34, 36 is lower than a predetermined threshold, and
(B.3) optionally adapts the transmitting power dependent on its localization within the group of cars 10, 12, 14, 16.

FIG. 4 depicts the relay control box 40 in more detail. Said relay control box 40 comprises a neighbor list or neighbor table 410 being designed for storing the arriving messages 32, 34, 36.

These arriving messages 32, 34, 36 are sent by the neighboring cars 12, 14, 16 (cf. FIGS. 2, 3) and comprise information regarding the neighboring nodes 12, 14, 16, namely regarding
the respective current position of the neighboring nodes 12, 14, 16,
the respective moving direction of the neighboring nodes 12, 14, 16,
the respective speed of the neighboring nodes 12, 14, 16,
a respective network identification number of the neighboring nodes 12, 14, 16,
the respective power at which the arriving message 32, 34, 36 had been transmitted, and
a respective time stamp.

For receiving the arriving messages 32, 34, 36 from the receiver unit 30, the relay control box 40 comprises a receiver interface 430 being supplied with signal 304.

Said receiver interface 430 is connected with a message analyzing unit 450 for
evaluating the subject or the type of the arriving messages 32, 34, 36, in particular for evaluating if the arriving message 32, 34, 36 is a hello message and/or a warning message,
for updating the information regarding the neighboring nodes 12, 14, 16, in particular the neighbor table 410, with part of the arriving message 32, 34, 36, namely with the hello messages, and
for sending a copy of part of the arriving message 32, 34, 36, namely of the warning message, to the display unit 80 and to a retransmission controlling unit 440.

To this aim, the message analyzing unit 450 is connected to the receiver interface 430 as well as to the neighbor table 410 as well as to the retransmission controlling unit 440.

Said retransmission controlling unit 440 is provided with the receiving power 504 as calculated by the power estimating unit 50 (cf. FIGS. 1 and 2) and is designed
for evaluating if one or more of the arriving messages 32, 34, 36 have to be retransmitted and
for calculating said transmitting power, in case one or more of the arriving messages 32, 34, 36 have to be retransmitted.

For transmitting the message 22 being generated by the retransmission controlling unit 440 to the transmission unit 20, the relay control box 40 comprises a transmission interface 420 being connected to the retransmission controlling unit 440.

Moreover, the message 22 can be generated by a warning message generating unit 460 being connected to the transmission interface 420 and being designed for providing the transmission interface 420 with one or more warning messages.

For generating hello messages 22, the relay control box 40 comprises a hello message generating unit 470 being connected to the transmission interface 420 and being designed for providing the transmission interface 420 with hello messages 22.

Said hello message 22 comprises information regarding
the current position of the respective car 10, as supplied by the G[lobal]P[ositioning]S[ystem] unit 60 (cf. FIGS. 1, 2 and 3),
the moving direction of the respective car 10, as supplied by the G[lobal]P[ositioning]S[ystem] unit 60 (cf. FIGS. 1, 2 and 3),
the speed of the respective car 10, as supplied by the car bus interface 72 (cf. FIGS. 1 and 2),
a respective network identification number of the respective car 10,
the respective transmitting power at which the message 22 is transmitted, and
a respective time stamp.

Said G[lobal]P[ositioning]S[ystem] is important for the content of the warning message, but is not strictly necessary for the hello message handling (generation and neighbor list storage) and for the functioning of at least one power control algorithm; this power control algorithm also allows to save battery power.

The neighbor table 410 is designed for storing a path loss calculation value (cf. table 1, table 2 and table 3 below) being calculated by the controller unit 40 by subtracting the receiving power 504 from the power at which the arriving message 32, 34, 36 had been transmitted, wherein said transmitting power of the arriving message 32, 34, 36 is known from part of the arriving message 32, 34, 36, namely from the hello message.

For sorting the information regarding the neighboring nodes 12, 14, 16 in the neighbor table 410 according to increasing path loss calculation values, namely for grouping the information regarding the neighboring nodes 12, 14, 16 in the neighbor table 410 according to discrete path loss calculation intervals (cf. table 1, table 2 and table 3 below), the relay control box 40 comprises a power control subsystem 480.

Said power control subsystem 480 is connected to the neighbor table 410 as well as to the retransmission controlling unit 440 as well as to the warning message generating unit 460.

Thus, FIG. 4 gives an insight of the relay control box 40: messages can be generated
by the hello message generator 470,
by the warning message generator 460 and
by the retransmission controlling unit 440.

All these messages pass through the transmission interface 420, which is used to adapt the relay control box 40 to the different transmission protocols that can be used in the transmission unit 20 (cf. FIGS. 1, 2 and 3), before being sent as signals 204 to the transmission unit 20.

Messages 32, 34, 36 incoming from the receiver unit 30 (cf. FIGS. 1, 2 and 3) are passed as signals 304 to the receiver interface 430, which is used to adapt the relay control box 40 to the different transmission protocols that can be used in the receiver unit 30 (cf. cf. FIGS. 1, 2 and 3).

Then, the messages 32, 34, 36 are passed from the receiver interface 430 to the message analyzer 450 where it is decided if the arriving message 32, 34, 36 is a warning message or a hello message:
in case the incoming message 32, 34, 36 is a hello message, an entry is created (or updated) in the neighbor table 410, with the information provided by the message 32, 34, 36 plus the power 504 displayed by the power estimating unit 50;
in case the incoming message 32, 34, 36 is a warning message, the relay control box 40 sends a copy to the display 80 (cf. FIGS. 1 and 2) warning the driver, and at the same time the relay control box 40 delivers a copy to the retransmission controlling unit 440.

The retransmission controlling unit 440 can use different algorithms to decide if the message 32, 34, 36 should be re-broadcasted. The retransmission controlling unit 440 can
wait a random time and decide to transmit only if other copies of the same message 32, 34, 36 are not further received, or
use other algorithms, as for example described by Yu-Chee Tseng, Sze-Yao Ni, and En-Yu Shih in the article “Adaptive approaches to relieving broadcast storms in a wireless multihop mobile ad hoc network” [Transaction on Computers (IEEE)].

If the retransmission controlling unit 440 chooses to relay the warning, the transmitting power calculator or relay control unit 40 furnishes the adequate estimated value for the power control. The transmitting power calculator also furnishes the estimated power when a message 22 is for the first time generated by the warning message generator 460.

For calculating the transmitting power the relay control unit 40
determines a path loss value by summing the number of neighboring nodes 12, 14, 16 per path loss calculation value or per path loss calculation interval, starting from the lowest path loss calculation value or from the lowest path loss calculation interval and summing until the sum is equal to or bigger than a predetermined threshold indicating the average number of neighboring nodes 12, 14, 16 being able to receive the message 22, wherein the path loss value is equivalent to the last value or to the last interval of the summing (cf. table 1, table 2 and table 3 below),
calculates the value of the N[et]T[ransmitting]P[ower] by subtracting a predetermined sensitive parameter value from the path loss value, the predetermined sensitive parameter indicating the minimum power being receivable
by the respective car 10 in order to decode correctly the arriving message 32, 34, 36, and/or
by the neighboring cars 12, 14, 16 in order to decode correctly the message 22, and
calculates the value of the G[ross]T[ransmitting]P[ower] by summing a safety margin value to the value of the N[et]T[ransmitting]P[ower], wherein the G[ross]T[ransmitting]P[ower] is used by the transmission unit 20 for broadcasting the message 22.

Table 1 specifies the details of the neighbors' table 410 and displays the grouping of neighbor cars 12, 14, 16 in different path loss intervals (classes), as actuated by the power control subsystem 480 (cf. FIG. 4):

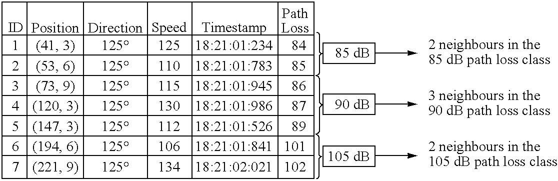

This path loss interval is equal to five path loss intervals in table 1, but can be any value defined by the parameter “Interval_Span” in the power control subsystem 480.

Table 2 shows an example of calculation of transmitting power 504 for a low traffic scenario:

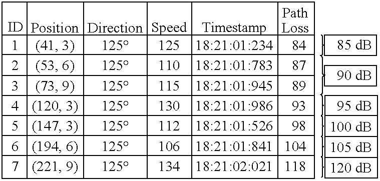

In more detail, table 2 describes how a warning message
can be triggered by the danger sensor 90,
thus can be generated by the warning message generator 460 in the relay control unit 40 and
then can be relayed by other nodes, with emphasis on the transmitting power calculation (the neighbor table 410 and the transmitted power 504 refer to the generation of the first message); in table 2, this calculation of the transmitting power is based on 95 d[eci]B[el] of path loss to reach four neighbors; for a margin of three d[eci]B[el] dB and for a sensitivity of −88 dBm the resulting transmitting power is 95 dBm+3 dBm−88 dBm, i.e. ten dBm.

The scenario of table 2 represents a low traffic situation as shown in FIG. 6A. It can be taken from table 2 that in such low traffic scenario the power used by the transmitter 20 is higher than in a high traffic situation as exemplified in table 3 and as shown in FIG. 6B.

Table 3 shows an example of calculation of transmission power or transmitting power 504 for a low traffic scenario (the neighbor table 410 and the transmitted power 504 refer to the first message generation):

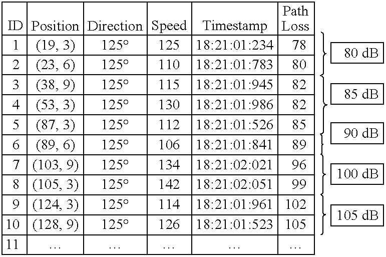

In more detail, table 3 describes the same example as described in table 2 and as shown in FIG. 6A but with higher traffic (cf. FIG. 6B). Here, the algorithm decides to transmit with lower power because the respective distance between the cars 12, 14, 16 is in the average shorter than in the previous example (cf. FIG. 6A).

As a consequence, in table 3 the calculation of the transmitting power is based on 85 d[eci]B[el] of path loss to reach four neighbors; for a margin of three d[eci]B[el] dB and for a sensitivity of −88 dBm the resulting transmitting power is 85 dBm+3 dBm−88 dBm, i.e. zero dBm.

Finally, some typical scenarios are given where the communication system 200 can operate to deliver warning dissemination.

The communication system 200 is relevant for car to car communication, in particular to a connectivity system 200 for accident-free driving, where sensor-equipped cars 10, 12, 14, 16 interact cooperatively to avoid collisions. For example, car-to-car communication is considered crucial for intersection collision avoidance, in particular to avoid collisions when cars 12 are entering an intersection that should be kept free for instance for a fire truck 10 (cf. FIG. 7).

Likewise, the communication system (or connectivity system) 200 according to the present invention can be used for cooperative interaction of cars 10, 12, 14, 16 and for distributing in particular warning messages 22, 32, 34, 36, especially
in order to avoid collisions during lane change or merge manoeuvres (cf. FIG. 8A),
for reporting an accident on the lanes used (cf. FIG. 8B), and
for reporting an invisible obstacle, for example an obscured or shadowed object (cf. FIG. 8C),

when vehicles are moving in different directions within the same area.

### LIST OF REFERENCE NUMERALS

100 communication device being assigned to the reference node or respective node 10
100′ communication device being assigned to the neighboring node 12, 14, 16
10 reference node or respective node, in particular first vehicle
12 first neighboring node, in particular first neighboring vehicle
14 second neighboring node, in particular node in the central area
16 third neighboring node, in particular node in the border area
20 transmission unit or sender unit, in particular sender block
204 signal from controller unit 40, in particular from transmission interface 420, to transmission unit or sender unit 20
22 message broadcasted to the neighboring nodes 12, 14, 16
23 receiving/transmitting antenna, assigned to transmission unit or sender unit 20 as well as to receiver unit or receptor unit 30
30 receiver unit or receptor unit, in particular receptor block
30s selection part of the receiver unit or receptor unit 30
304 signal from receiver unit or receptor unit 30 to controller unit 40, in particular to receiver interface 430
32 arriving message sent by the first neighboring node 12
34 arriving message sent by the second neighboring node 14
36 arriving message sent by the third neighboring node 16
40 controller unit, in particular power selection unit, for example relay control box
410 neighbor list or neighbor table of the controller unit 40
420 transmission interface of the controller unit 40
430 receiver interface of the controller unit 40
440 retransmission controlling unit of the controller unit 40
450 message analyzing unit of the controller unit 40
460 warning message generating unit of the controller unit 40
470 hello message generating unit of the controller unit 40
480 power control subsystem of the controller unit 40
50 power estimating unit or power estimator block
504 receiving power at which the arriving message 32, 34, 36 is received and which is calculated by the power estimating unit 50
60 localization unit, in particular position determining unit, for example G[lobal]P[ositioning]S[ystem] unit or G[lobal]P[ositioning]S[ystem] block
604 signal from localization unit 60 to controller unit 40, in particular to hello message generating unit 470
62 localization antenna, in particular position determining antenna, for example G[lobal]P[ositioning]S[ystem] antenna, assigned to localization unit 60
70 data bus
72 car bus interface
724 signal from communication device 100, 100′, in particular from car bus interface 72 to car bus intra-vehicle system 74
74 car bus intra-vehicle system
80 display unit
804 signal from controller unit 40, in particular from message analyzing unit 450, to display unit 80
90 danger sensing unit
904 signal from danger sensing unit 90 to controller unit 40, in particular to warning message generating unit 460, for example sensor trigger signal
200 communication system or arrangement for inter-node, in particular inter-vehicle, communicating

1. A communication device (100, 100′) for communication between and among mobile nodes (10, 12, 14, 16), in particular between and among vehicles, comprising
at least one transmission unit (20), in particular at least one sender block, for broadcasting at least one message (22), in particular at least one hello message and/or at least one warning message, and
at least one receiver unit (30), in particular at least one receptor block, for sensing at least one arriving message (32, 34, 36), in particular at least one hello message and/or at least one warning message, being broadcasted by at least one neighboring node (12, 14, 16),
characterized by
at least one controller unit (40), in particular at least one relay control box, for calculating and/or for selecting the transmitting power for broadcasting the message (22).

2. The communication device according to claim 1, characterized in that the transmitting power is calculated and/or selected by processing at least part of the arriving message (32, 34, 36), in particular by processing at least one information regarding the neighboring nodes (12, 14, 16).

3. The communication device according to claim 1, characterized in
that the receiver unit (30) is designed for determining the distance and/or number of the neighboring nodes (12, 14, 16) by means of the arriving messages (32, 34, 36), and
that the transmitting power is dependent on the distance and/or number of the neighboring nodes (12, 14, 16), in particular on the average number of nodes as determined from the respective numbers of nodes sensed by the respective neighboring nodes (12, 14, 16).

4. The communication device according to claim 1, characterized in
that the transmitting power is reduced with increasing number of arriving messages (32, 34, 36), in particular when the number of arriving messages (32, 34, 36) is higher than a predetermined threshold, and
that the transmitting power is increased with decreasing number of arriving messages (32, 34, 36), in particular when the number of arriving messages (32, 34, 36) is lower than a predetermined threshold.

5. The communication device according to claim 1, characterized in
that at least one localization unit (60), in particular at least one G[lobal]P[ositioning]S[ystem] unit, for determining the position of the respective node (10), in particular for determining the localization of the reference node within at least one group of nodes (10, 12, 14, 16), is provided, the localization unit (60), in particular
being connected to the controller unit (40) and
being designed for receiving signals via at least one localization antenna (62), for instance via at least one G[lobal]P[ositioning]S[ystem] antenna, in particular regarding the current position of the respective node (10) and/or regarding the moving direction of the respective node (10), and/or
that the selection of the transmitting power is dependent on the localization of the respective node (10) within at least one group of nodes (10, 12, 14, 16), in particular that at least one node (14) in the central area of the group has a lower transmitting power than at least one node (16) in the border area of the group.

6. The communication device according to claim 1, characterized by
at least one power estimating unit (50)
being connected to the receiver unit (30) as well as to the controller unit (40) and
being designed for calculating at least one receiving power (504) at which the arriving message (32, 34, 36) is received, and/or
at least one car bus interface (72)
being connected to the controller unit (40) and
being designed for supplying the controller unit (40) with the speed of the respective node (10), and/or
at least one display unit (80)
being connected to the controller unit (40) and
being designed for displaying at least one message, in particular the arriving message (32, 34, 36), and/or
at least one danger sensing unit (90)
being connected to the controller unit (40) and
being designed for sensing at least one subject being relevant, in particular being dangerous, for the respective node (10).

7. The communication device according to claim 1, characterized in that the controller unit (40) comprises at least one neighbor list or neighbor table (410) being designed for storing the arriving message (32, 34, 36), the arriving message (32, 34, 36) comprising information regarding the neighboring nodes (12, 14, 16), in particular regarding
the respective current position of the neighboring nodes (12, 14, 16),
the respective moving direction of the neighboring nodes (12, 14, 16),
the respective speed of the neighboring nodes (12, 14, 16),
at least one respective network identification number of the neighboring nodes (12, 14, 16),
the respective power at which the arriving message (32, 34, 36) had been transmitted, and/or
at least one respective time stamp.

8. The communication device according to claim 7, characterized in that the controller unit (40) comprises
at least one receiver interface (430) for receiving the arriving message (32, 34, 36) from the receiver unit (30) and/or
at least one retransmission controlling unit (440)
being connected to the neighbor list or neighbor table (410) and
being designed
for evaluating if the arriving message (32, 34, 36) has to be retransmitted and
for calculating said transmitting power, in case the arriving message (32, 34, 36) has to be retransmitted, and/or
at least one message analysing unit (450)
being connected to the receiver interface (430) as well as to the neighbor list or neighbor table (410) as well as to the retransmission controlling unit (440),
being provided with the receiving power (504) as calculated by the power estimating unit (50) and
being designed
for evaluating the subject and/or the type of the arriving message (32, 34, 36), in particular for evaluating if the arriving message (32, 34, 36) is a hello message and/or a warning message,
for updating the information regarding the neighboring nodes (12, 14, 16), in particular the neighbor list or neighbor table (410), with at least part of the arriving message (32, 34, 36), in particular with the hello message, and
for sending at least one copy of at least part of the arriving message (32, 34, 36), in particular of the warning message, to the display unit (80) and/or to the retransmission controlling unit (440) and/or
at least one transmission interface (420)
being connected to the retransmission controlling unit (440) and
being designed for transmitting the message (22) to the transmission unit (20) and/or
at least one warning message generating unit (460)
being connected to the transmission interface (420) and
being designed for providing the transmission interface (420) with at least one warning message and/or
at least one hello message generating unit (470)
being connected to the transmission interface (420) and
being designed for providing the transmission interface (420) with at least one hello message, said hello message comprising information regarding
the current position of the respective node (10), in particular supplied by the localization unit (60),
the moving direction of the respective node (10), in particular supplied by the localization unit (60),
the speed of the respective node (10), in particular supplied by the car bus interface (72),
at least one network identification number of the respective node (10),
the respective transmitting power at which the message (22) is transmitted, and/or
at least one respective time stamp.

9. The communication device according to claim 7, characterized in
that the neighbor list or neighbor table (410) is designed for storing at least one path loss calculation value being calculated by the controller unit (40) by subtracting the receiving power (504) from the power at which the arriving message (32, 34, 36) had been transmitted, said power being known from at least part of the arriving message (32, 34, 36), in particular from the hello message, and
that the controller unit (40) comprises at least one power control subsystem (480)
being connected to the retransmission controlling unit (440) as well as to the warning message generating unit (460) as well as to the neighbor list or neighbor table (410) and
being designed
for sorting the information regarding the neighboring nodes (12, 14, 16) in the neighbor list or neighbor table (410) according to increasing path loss calculation values and/or
for grouping the information regarding the neighboring nodes (12, 14, 16) in the neighbor list or neighbor table (410) according to discrete path loss calculation intervals,
in particular when the retransmission controlling unit (440) and/or the warning message generating unit (410) request to transmit the message (22).

10. The communication device according to claim 1, characterized in that the controller unit (40) is designed
for determining at least one path loss value by summing the number of neighboring nodes (12, 14, 16) per path loss calculation value or per path loss calculation interval, starting from the lowest path loss calculation value or from the lowest path loss calculation interval and summing until the sum is equal to or bigger than a predetermined threshold indicating the average number of neighboring nodes (12, 14, 16) being able to receive the message (22), wherein the path loss value is equivalent to the last value or to the last interval of the summing,
for calculating the value of the net transmitting power by subtracting a predetermined sensitive parameter value from the path loss value, the predetermined sensitive parameter indicating the minimum power being receivable
by the respective node (10) in order to decode correctly the arriving message (32, 34, 36) and/or
by the neighboring nodes (12, 14, 16) in order to decode correctly the message (22), and/or
for calculating the value of the gross transmitting power by summing at least one safety margin value to the value of the net transmitting power, wherein the gross transmitting power is used by the transmission unit (20) for broadcasting the message (22).

11. The communication device according to the preamble of claim 1,
characterized in
that the respective arriving message (32, 34, 36) contains the respective number of nodes as sensed by the respective neighboring node (12, 14, 16),
that the receiver unit (30) is designed for determining an average number of nodes from these numbers of respectively sensed nodes, and
that the receiver sensitivity is adjusted to this average number of nodes, in particular by at least one selection part (30s) of the receiver unit (30).

12. A communication system (200) for communication between and among mobile nodes (10, 12, 14, 16), in particular between and among vehicles,
characterized by
at least two communication devices (100, 100′) according to claim 1 wherein
at least one (100) of the communication devices (100, 100′) is assigned to the respective node (10), in particular to the reference node, for example to the considered car, and
at least one (100′) of the communication devices (100, 100′) is assigned to the neighboring node (12, 14, 16), in particular to the neighboring car.

13. The communication system according to claim 12, characterized in that each node (10, 12, 14, 16) comprises at least one communication device (100, 100′) for communication between and among mobile nodes (10, 12, 14, 16), in particular between and among vehicles, comprising
at least one transmission unit (20), in particular at least one sender block, for broadcasting at least one message (22), in particular at least one hello message and/or at least one warning message, and
at least one receiver unit (30), in particular at least one receptor block, for sensing at least one arriving message (32, 34, 36), in particular at least one hello message and/or at least one warning message, being broadcasted by at least one neighboring node (12, 14, 16),
characterized by
at least one controller unit (40), in particular at least one relay control box, for calculating and/or for selecting the transmitting power for broadcasting the message (22).

14. A method for communication between and among mobile nodes (10, 12, 14, 16), in particular between and among vehicles, with each node (10, 12, 14, 16)
broadcasting at least one message (22), in particular at least one hello message and/or at least one warning message, and
receiving at least one arriving message (32, 34, 36), in particular at least one hello message and/or at least one warning message, being broadcasted by at least one neighboring node (12, 14, 16),
characterized in
that the transmitting power for broadcasting the message (22) is selected and/or calculated.

15. The method according to claim 14, characterized in that the transmitting power is calculated and/or selected by processing at least part of the arriving message (32, 34, 36), in particular by processing at least one information regarding the neighboring nodes (12, 14, 16).

16. The method according to claim 14, characterized in
(A) that the distance and/or number of the neighboring nodes (12, 14, 16) is determined by means of the arriving messages (32, 34, 36), and
(B) that the transmitting power for broadcasting the message (22) is calculated and/or selected in dependence on the distance and/or number of the neighboring nodes (12, 14, 16), in particular in dependence on the average number of nodes as determined from the respective numbers of nodes sensed by the respective neighboring nodes (12, 14, 16).

17. The method according to claim 14, characterized in
(B.1) that the respective node (10), in particular the reference node, reduces its transmitting power when the number of arriving messages (32, 34, 36) increases, in particular when the number of arriving messages (32, 34, 36) is higher than a predetermined threshold, and
(B.2) that the respective node (10) increases its transmitting power when the number of arriving messages (32, 34, 36) decreases, in particular when the number of arriving messages (32, 34, 36) is lower than a predetermined threshold.

18. The method according to claim 14, characterized in
(A.1) that the position of the respective node (10), in particular that the localization of the reference node within at least one group of nodes (10, 12, 14, 16), is determined, and/or
(B.3) that the transmitting power is optionally selected and/or optionally adapted dependent on the localization of the respective node (10) within at least one group of nodes (10, 12, 14, 16), in particular that at least one node (14) in the central area of the group transmits with a lower power than at least one node (16) in the border area of the group.

19. The method according to the preamble of claim 14,
characterized in
that the respective arriving message (32, 34, 36) contains the respective number of nodes as sensed by the respective neighboring node (12, 14, 16),
(C) that the respective node (10) calculates an average number of nodes from these numbers of respectively sensed nodes, and
(D) that the respective node (10) adapts its receiver sensitivity dependent on the average number of nodes.

20. The method according to claim 19, characterized in,
(D.1) that the respective receiver sensitivity is increased with a certain percentage when the number of nodes being sensed by the respective node (10) is lower than the average number of sensed nodes, and
(D.2) that the respective receiver sensitivity is decreased with a percentage smaller than the certain percentage when the number of nodes being sensed by the respective node (10) is higher than the average number of sensed nodes.

21. The method according to claim 14, characterized in
(i) that at least one receiving power (504) is calculated at which the arriving message (32, 34, 36) is received,
(ii) that the subject and/or the type of the arriving message (32, 34, 36) is evaluated, in particular that it is evaluated if the arriving message (32, 34, 36) is a hello message and/or a warning message,
(iii) that at least part of the arriving message (32, 34, 36), in particular the hello message, is stored and/or updated, wherein said part of the arriving message (32, 34, 36) comprises information regarding the neighboring nodes (12, 14, 16), in particular regarding
the respective current position of the neighboring nodes (12, 14, 16),
the respective moving direction of the neighboring nodes (12, 14, 16),
the respective speed of the neighboring nodes (12, 14, 16),
at least one respective network identification number of the neighboring nodes (12, 14, 16),
the respective power at which the arriving message (32, 34, 36) had been transmitted, and/or
at least one respective time stamp,
(iv) that at least part of the arriving message (32, 34, 36), in particular the warning message, is displayed,
(v.a) that it is evaluated, if the arriving message (32, 34, 36), in particular the warning message, has to be retransmitted, and
(v.b) that in case the arriving message (32, 34, 36) has to be retransmitted, said transmitting power is calculated.

22. The method according to claim 21, characterized in
(v.b.1) that at least one path loss calculation value is calculated by subtracting the receiving power (504) from the power at which the arriving message (32, 34, 36) had been transmitted, said power being known from at least part of the arriving message (32, 34, 36), in particular from the hello message,
(v.b.2) that the information regarding the neighboring nodes (12, 14, 16) is
sorted according to increasing path loss calculation values and/or
grouped according to discrete path loss calculation intervals,
(v.b.3) that at least one path loss value is determined by summing the number of neighboring nodes (12, 14, 16) per path loss calculation value or per path loss calculation interval, starting from the lowest path loss calculation value or from the lowest path loss calculation interval and summing until the sum is equal to or bigger than a predetermined threshold indicating the average number of neighboring nodes (12, 14, 16) being able to receive the message (22), wherein the path loss value is equivalent to the last value or to the last interval of the summing,
(v.b.4) that the value of the net transmitting power is calculated by subtracting a predetermined sensitive parameter value from the path loss value, the predetermined sensitive parameter indicating the minimum power being receivable
by the respective node (10) in order to decode correctly the arriving message (32, 34, 36) and/or
by the neighboring nodes (12, 14, 16) in order to decode correctly the message (22), and/or
(v.b.5) that the value of the gross transmitting power is calculated by summing at least one safety margin value to the value of the net transmitting power, wherein the gross transmitting power is used by the transmission unit (20) for broadcasting the message (22).

23. The method according to claim 14, characterized in that in case no hello message is received from a certain neighboring node (12, 14, 16) for a certain time, in particular for a time value higher than a predetermined threshold, the information regarding said neighboring node (12, 14, 16) is deleted.

24. Use of at least one communication system (200) according to claim 12
for at least one multi-purpose communication device, in particular for providing a reliable broadcast mechanism with power control subsystem, and/or
for at least one wireless ad hoc network, in particular for at least one sensor network or for wireless local danger warning with the ability of self-adaptation to different circumstances and scenarios, for example for car-to-car communication, wherein cars interact cooperatively and distribute for example warning messages, especially for accident-free driving, for instance
in order to avoid collisions during lane change or merge manoeuvres and
for reporting invisible obstacles, for example obscured or shadowed objects,
when vehicles are moving in different directions within the same area.
